(19) United States
(12) Patent Application Publication
(10) Pub. No.: US 2002/0150699 A1
(43) Pub. Date: Oct. 17, 2002

(54) Multi-flex branch

(76) Inventor: John B. Box, Mineral Wells, TX (US)

Correspondence Address: James E. Bradley, BRACEWELL & PATTERSON, LLP, P.O. Box 61389, Houston, TX, 77208-1389, US

(21) Appl. No.: 10/121,296

(22) Filed: Apr. 12, 2002

Related U.S. Application Data
(60) Provisional application No. 60/283,499, filed on Apr. 12, 2001.

(51) Int. Cl. A41G 1/00; B23P 15/26

(52) U.S. Cl. 428/18; 29/890.043

(57) ABSTRACT

A method of manufacturing artificial foliage utilizes a plastic pipe framework. The pipes are secured together to form a spine with a number of lateral members extending from it. The framework is wrapped with a layer of permeable fiberglass tape. A resin layer is coated on the fiberglass tape. The resin layer has a color and texture to simulate bark. Some of the resin permeates the fiberglass tape and contacts the pipes. Some of the pipes on the lateral members have upturned ends. Artificial leaves are attached to the resin layer on the lateral members.

### CROSS-REFERENCE TO RELATED APPLICATION

This application claims the benefit of provisional patent application 60/283,499, filed Apr. 12, 2001.

### TECHNICAL FIELD OF THE INVENTION

This invention relates to artificial foliage, such as tree limbs and branches. More particularly, this invention refers to branches that are used for exterior Christmas trees, landscaping, utilities, and telecommunication systems that support aesthetic environments.

### BACKGROUND OF THE INVENTION

Artificial foliage has many uses. One use is to disguise telecommunication towers located in neighborhoods. A typical tower is a polygonal tapered pole with an antenna on top. It has been known in the past to attach artificial foliage to the pole and coat the pole with a resin layer to simulate tree bark. The result conceals the pole by making it appear to be a tree. This concealment techniques has been expensive, however. I is desirable that the limbs flex and move with the wind. They also must have adequate strength to avoid breakage.

One technique in the prior art employs plastic pipe as a framework. The plastic pipe is coated with a resin layer to simulate a branch. However, it is difficult to cause the resin to adhere permanently to the plastic pipe in a manner that still provides flexibility and adequate strength.

### SUMMARY OF THE INVENTION

A method of manufacturing artificial foliage uses plastic pipes as a framework. Pipes are joined together to form a limb. Preferably the pipes of the spine or main limb of the foliage are of gradually smaller diameters from a larger end to a smaller end. At least some of the limb pipes are joined together with T-shaped couplings, each of the couplings having first and second coaxial open ends that receive two of the limb pipes, and a lateral open end, pointing 90 degrees from the first and second ends. Branches or lateral members for the main limb are formed by securing plastic pipes to each of the lateral open ends of the couplings. T-shaped couplings are also used in the branches, each having coaxial first and second open ends and a 90 degree open end. Curved pipes having non-coaxial first and second ends are secured at the ends of the branches branch with the free end of the curved pipe inclined upward. Branch tip pipes are secured in upright configurations to upward facing 90 degree open ends of the branch couplings.

After forming the framework, the pipes and couplings are wrapped with a layer of permeable fiberglass tape. The fiberglass tape is then coated with a resin that has a color and texture to simulate bark. Some of the resin permeates the fiberglass tape and contacts the pipes and the couplings. Artificial leaves are secured to the resin layer on the lateral members.

### BRIEF DESCRIPTION OF THE DRAWINGS

FIG. 1 is a schematic view of a foliage assembly, shown during a first step in accordance with the invention.

FIG. 2 is a schematic view of the foliage assembly of FIG. 1, shown during a second step in accordance with the invention.

FIG. 3 is a schematic view of the foliage assembly of FIG. 1, shown during a third step in accordance with the invention.

FIG. 4 is a schematic view of the foliage assembly of FIG. 1 after completion.

FIG. 5 is an enlarged sectional view of a portion of the foliage assembly of FIG. 1, demonstrating the different layers.

FIG. 6 is an enlarged sectional view of the base portion of the foliage assembly of FIG. 1.

FIG. 7 is an enlarged sectional view of the foliage assembly of FIG. 1, taken along the line 7-7 of FIG.1.

### DETAILED DESCRIPTION OF THE PREFERRED EMBODIMENT

Referring to FIGS. 1-4 in the drawings, the preferred embodiments of process steps of assembling the foliage member 11 according to the present invention are schematically illustrated. First, as demonstrated in FIG. 1, a plurality of plastic pipes 17 are cut to a certain length which varies based on overall length of the spine of foliage member 11, the spine serving to simulate the woody portion of a limb or branch. The first pipe 17 is the largest in diameter and forms a base 13 of the limb or branch. Branches 4′ to 7′ in length require a 3″ base, while branches 8′ to 10′ in length require a 4″ base in the preferred method. Schedule 80 PVC (polyvinylchloride) pipes 17 are preferably used to form the spine. Though fairly rigid, once joined to form a limb, pipes 17 are capable of flexing along the lengths of the limb.

Pipes 17 are of gradually smaller diameter from base 13 to the tip. Some of the pipes 17 are secured directly to each other by inserting one pipe 17 into the bore of another pipe 17. Couplings 18 are also used to join pipes 17. Couplings 18 are T-shaped, having coaxial first and second ends 18a, 18b and a lateral end 18c that faces 90 degrees from ends 18a, 18b. Each end 18a, 18b, and 18c is open.

A lateral pipe 20 inserts into each open lateral end 18c to form branches or smaller limbs from the central limb or spine. Each lateral pipe 20 is also a PVC plastic pipe. Although not shown, depending upon length, the lateral pipes could also decrease in diameter and insert into one another. At least one coupling 22 is preferably located in each lateral member, joining two of the lateral pipes 20. Couplings 22 are also T-shaped, having two open coaxial ends and one 90 degree end facing 90 degrees from the coaxial ends.

A curved end pipe 19 is attached to the second end of each of the couplings 22. The end pipes 19 are elbow-shaped, with the ends 19a and 19b being non-coaxial, preferably at 90 degrees relative to one another. Also, end pipes 19 are secured to couplings 22 so that their free ends 19b are out of the plane 16 (FIG. 7) that contains lateral pipes 20 and spine pipes 17. As illustrated in FIG. 7, spine pipes 17 and lateral pipes 20 are typically installed on a pole (not shown) in the horizontal plane 16. End pipes 19 are secured in lateral couplings 22 so their free ends 19b incline upward at an angle b that is preferably 30 degrees upward relative to plane 16. End pipes 19 are also plastic pipes.

A tip pipe 24 of plastic is inserted into the 90 degree end of each coupling 22. Tip pipes 24 are fairly short pipes that terminate in a free end. Lateral couplings 22 are oriented so that tip pipes 24 will be parallel to the free ends 19b of end pipes 19. Tip pipes 24 will thus also be 30 degrees out of plane 16. Once foliage assembly 11 is installed, tip pipes 24 and the free ends of end pipes 19 point upward at a 30 degree angle. The various pipes 17, 19, 20, 24 and couplings 18, 22 are joined to respective members by an adhesive.

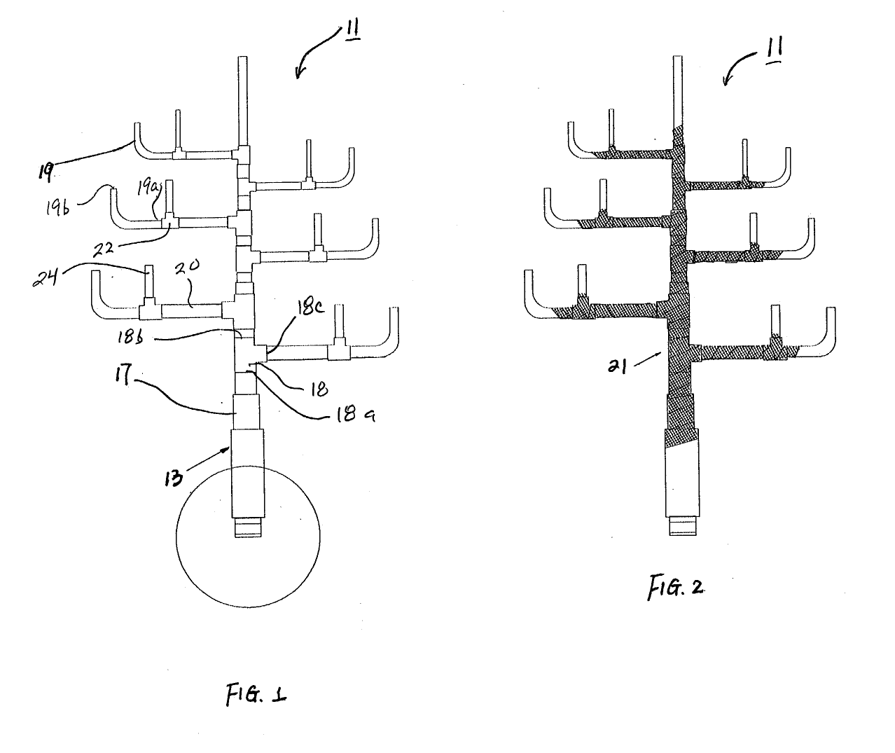

Once the framework of plastic pipes 17, 19, 20, 24 is secured as in FIG. 1, fiberglass mesh tape 21 is used to wrap around all of the pipes and couplings, as illustrated in FIG. 2.. Tape 21 has an adhesive backing 21a that causes it to adhere to pipes 17, 19, 20, 24 and couplings . The wrapping provides interior substrength and flexibility. Fiberglass mesh tape 21 is made of a woven material, which is not unidirectional. Additionally, tape 21 is porous to ensure penetration. Fiberglass is advantageous over nylon material in providing flexibility.

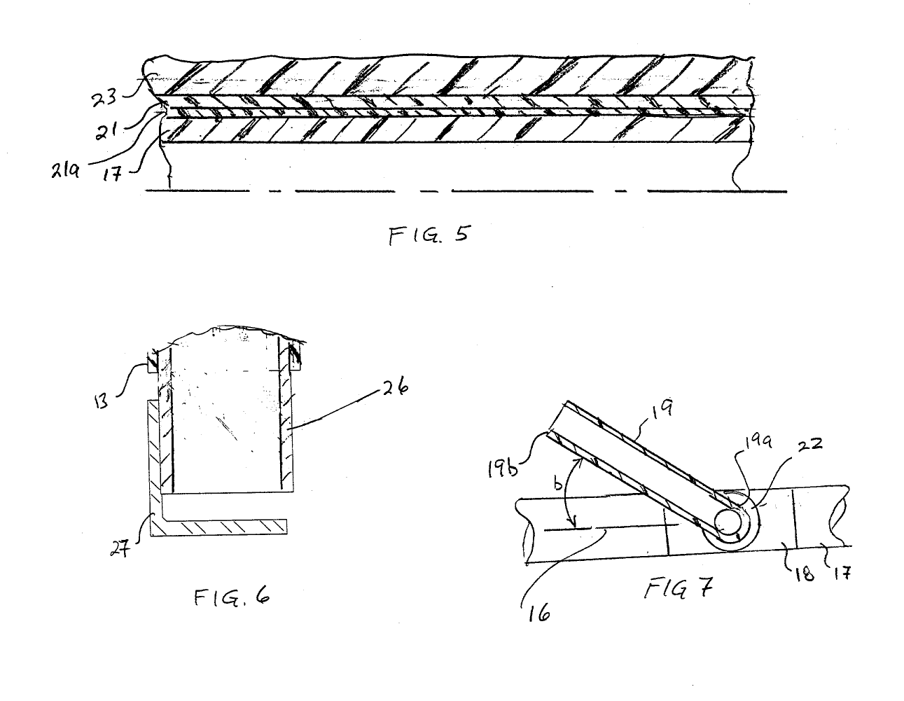

As demonstrated in FIG. 3 and shown in FIG. 5, exterior structural skin or resin layer 23 is applied by hand to pipe and coupling structure of foliage assembly 11. Exterior structural skin 23 is preferably a simulated bark material, having the color and shape of tree bark. This process consists of mixing specific materials and quantities for adhesion, strength and appearance. A specific example of the structural bark materials includes Freman 40-5711 Resin (about 2 gallons), Flex Resin S-628 (about 4 oz), Norac Catalyst (about 2 oz),½′ chopped fiber strands (about 5 cups), Sierra Brown Chrome Tex Pigment (about 2 oz), Aerosil or Renfill 3080 (about 5 cups) and fiberglass mesh (about 100 feet). When applied, some of the structural bark material passes through fiberglass mesh tape 21 into contact with pipes 17, 19, 20 and 24 and couplings 18 and 22. The resin that forms resin layer 23 is in a putty-like form and may be applied by hand.

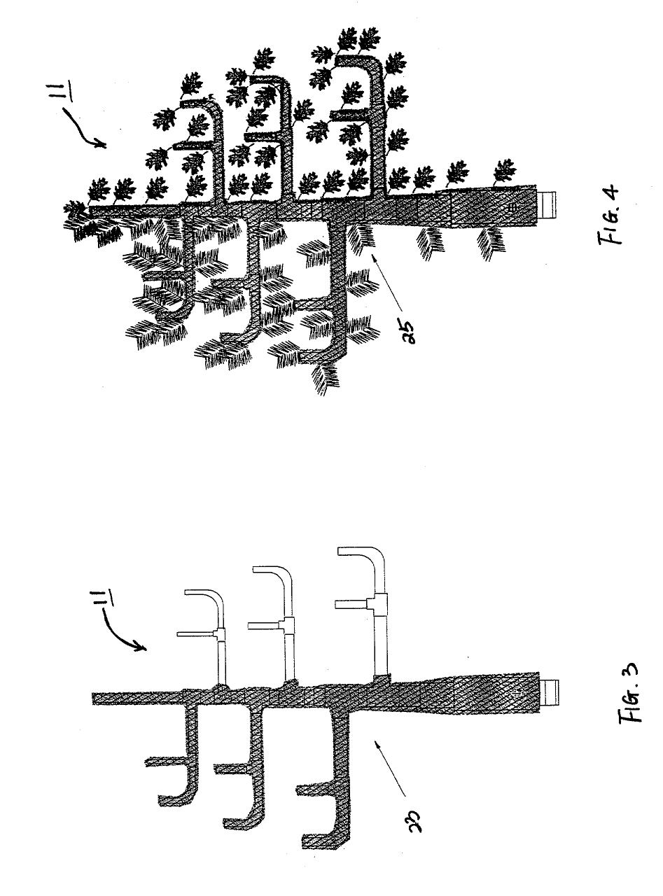

Finally, referring to FIG. 4, individual foliage or leaves 25 are secured to the spine and lateral members of the pipe and coupling structure of foliage assembly 11. Foliage 25 may simulate the leaves of deciduous trees or the thin narrow leaves, also called needles, of conifers. The leaves thus maybe artificial oak leaves, fur needles, redwood needles, pine needles, sruce needles and other types of foliage coverage, which are designed to be suitable for exterior conditions. Foliage varies from 4″ to 24″ in length and are made of a fabric with a flexible plastic stem, in the case of deciduous leaves. Conifer needles may be made entirely of a plastic material.

To apply foliage 25 to the spine and lateral member os branch structure 11, holes are first drilled at selected points in various pipes 17, 20, 24 and couplings 18, 22 . The holes preferably span 360 degrees relative to the axis of each member. Then glue is applied to an end of the foliage member 25 and the end is inserted into one of the holes.

Resin layer 23 is cured in dry air at ambient temperature. Usually the temperature is kept above 60° F. The resin cures, but remains flexible. Consequently, foliage assembly 11 remains flexible so that it will move with wind movement..

Referring to FIG. 6, a preferred hanger is shown for attaching foliage assembly 11 (FIG. 4) to a pole, such as a telecommunications tower (not shown). A steel angle bracket 27 is welded to a steel pipe 29. Steel pipe 29 is inserted and glued into base plastic pipe 13. Bracket 27 comprises a metal plate bent at 90 degrees. This results in a downward facing clip portion that is spaced from the end of steel pipe 29 by a clearance. Bracket 27 fits into a slot or a lug on a telecommunications pole (not shown). When installed, branch pipes 17 and 20 of the spine and lateral members will typically be in horizontal plane 16 (FIG. 7), which is perpendicular to the pole. The free ends 19b of end pipes 19 and the tip pipes 24 will be pointing upward at about a 30 degree angle.

The foliage assembly may be used for exterior Christmas trees, landscaping, utilities, or telecommunication systems, as mentioned, to provide an aesthetic environment. The foliage assembly can also be attached to lamp posts, sign posts, or any other post or shaft, including flag poles.

The present invention provides an attractive, simple, and relatively inexpensive way to construct an artificial foliage assembly. The foliage member is flexible so as to move with wind, yet has adequate strength due to the woven fiberglass tape..

While the invention has been shown or described in only some of its forms, it should be apparent to those skilled in the art that it is not so limited, but is susceptible to various changes without departing from the scope of the invention.

I claim:

1. A method of manufacturing artificial foliage, comprising:
(a) securing a plurality of plastic pipes together to form a spine and a plurality of lateral members extending therefrom;
(b) wrapping the pipes with a layer of permeable fiberglass tape;
(c) coating the layer of fiberglass tape with a resin layer that has a color and texture to simulate tree bark, with some of the resin layer permeating the fiberglass tape and contacting the pipes; and
(d) attaching artificial leaves to the lateral members.

2. The method according to claim 1, wherein step (a) comprises providing at least some of the lateral members with upward extending free ends.

3. The method according to claim 1, wherein the fiberglass tape of step (b) comprises woven fiberglass having an adhesive backing.

4. The method according to claim 1, wherein step (a) comprises providing one of the pipes for the spine with a larger diameter than the other pipes in the spine, and placing said one of the pipes at a first end of the spine.

5. The method according to claim 1, wherein step (a) comprises joining at least some of the pipes with couplings.

6. The method according to claim 1, wherein step (a) comprises joining at least some of the pipes with T-shaped couplings, each coupling having first and second open ends that are coaxial for receiving two of the pipes of the spine and a laterally extending leg that has an open end to receive one of the pipes of one of the lateral members.

7. The method according to claim 1, wherein step (c) comprises mixing chopped fiberglass into the resin layer.

8. The method according to claim 1, further comprising attaching a bracket to a first end of the spine, the bracket being an angular plate for attaching to a pole.

9. A method of manufacturing artificial foliage, comprising:
(a) securing a plurality of plastic limb pipes together to form a limb, the limb pipes being of gradually smaller diameters from a larger end to a smaller end, at least some of the limb pipes being joined together with T-shaped limb couplings, each of the limb couplings having first and second open ends that receive two of the limb pipes, and a lateral open end;
(b) securing a first end of a branch pipe to each of the lateral open ends of the limb couplings;
(c) providing a plurality of T-shaped branch couplings, each having coaxial first and second open ends and a generally upward facing open end, and securing the first end of each of the branch couplings to the second end of one of the branch pipes;
(d) providing a plurality of curved pipes, each of the curved pipes having non-coaxial first and second ends, and securing the first end of each curved pipe to the second end of one of the branch couplings with the second end of the curved pipe inclining generally upward;
(e) providing a plurality of branch tip pipes and securing them in upward inclined positions to the generally upward facing open ends of the branch couplings; then
(f) wrapping the pipes and couplings with a layer of permeable fiberglass tape;
(c) coating the layer of fiberglass tape with a resin layer that has a color and texture to simulate bark, causing some of the resin layer to permeate the fiberglass tape and contact the pipes and the couplings; and
(d) attaching artificial leaves to the branch pipes.

10. The method according to claim 9, wherein the fiberglass tape of step (c) comprises woven fiberglass having an adhesive backing.

11. The method according to claim 9, wherein step (c) comprises mixing chopped fiberglass into the resin layer.

12. The method according to claim 9, further comprising attaching a bracket to the larger end of the limb, the bracket being an angular plate for attaching to a trunk member.

13. An artificial foliage member, comprising:
a plurality ofplastic pipes secured together to define a spine member and a plurality of lateral members extending therefrom;
a layer of permeable fiberglass tape wrapped around the spine member and the lateral members;
a resin layer coating on the layer of fiberglass tape, the resin layer having a color and texture to simulate tree bark, with some of the resin layer permeating the fiberglass tape and being in contact with the pipes; and
a plurality of artificial leaves attached to the lateral members.

14. The foliage member according to claim 13, wherein at least some of the lateral members have generally upturned free ends.

15. The foliage member according to claim 13, wherein the fiberglass tape comprises woven fiberglass having an adhesive backing.

16. The foliage member according to claim 13, wherein the pipes of the spine member have differing diameters, the diameters gradually being smaller from a larger end of the spine member to a smaller end of the spine member.

17. The foliage according to claim 13, further comprising couplings joining at least some of the pipes together.

18. The foliage according to claim 13, further comprising a plurality of T-shaped couplings, each T-shaped coupling having first and second open ends that are coaxial for receiving two of the pipes and a laterally extending leg that has an open end to receive one of the pipes of one of the lateral members.

19. The foliage according to claim 13, further comprising chopped fiberglass in the resin layer.

20. The foliage according to claim 13, further comprising a bracket secured to a first end of the spine member, the bracket being an angular plate for attaching to a pole.
